(19) United States
(12) Patent Application Publication
(10) Pub. No.: US 2006/0106800 A1
(43) Pub. Date: May 18, 2006

(54) System and method for localization of electronic devices

(75) Inventors: Jukka Ollikainen, (US); Tomi Viitala, (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/978,599

(22) Filed: Nov. 1, 2004

(51) Int. Cl. G06F 17/30

(52) U.S. Cl. 707/9

(57) ABSTRACT

Embodiments of the present invention include device, methods, and computer code products for localization of electronic devices. The device includes a file system including a data item, and a localization system adapted to localize a received pathname using a stored identifier associated with the pathname. The pathname includes at least one data item name.

### BACKGROUND OF THE INVENTION

The present invention relates generally to the field of electronic devices, and particularly to systems and methods of localizing electronic devices such as mobile phones.

Electronic devices, such as mobile or cellular phones, may be adapted to accommodate different languages for different users. This accommodation is generally referred to as “localization.” Localization means that a device can be used by users in differing locales of the world.

In addition to displaying various messages and options in the language selected by the user, such devices may require displaying, reading or writing names of files, directories or sub-directories to identify a pathname of a file, directory or sub-directory in a file system of the device. Such localization has been achieved in the prior art with limitations.

FIG. 1 illustrates one such prior art localization arrangement. In this arrangement, the electronic device 100 includes a user interface 110 adapted to allow a user to interact with the device 100. The user interface 110 may be graphical or text-based interface. The system 100 also includes a file system 120. Each file and directory in the file system 120 includes attributes such as the name of the file or directory and the date and time it was created or last modified. One or more applications 130a, 130b may be provided to run on the device to provide certain functionality, for example. In addition, the electronic device 100 may include other components, such as an operating system and an application program interface (API), which are not illustrated in the figures for simplicity.

In prior art systems, such as that illustrated in FIG. 1, localization is achieved at the user interface. In FIG. 1, a localization module 150 is illustrated and interfacing with the user interface 10. The electronic device 100 may be provided with a set of resource files 140, each such file corresponding to a different language. For example, a resource file may be provided for English and another one for Finnish.

In arrangements such as that illustrated in FIG. 1, the change in the language is implemented at the user interface 10. The applications and other modules of the electronic device 100 function with the localization module 150 to display file and directory names, among others, in a language desired by the user. However, in such systems, it is possible that an application, suite or other component may be provided by a third-party. The third-party component may be incompatible with the localization, resulting in displaying of the file and directory names in the wrong language.

Other prior art arrangements result in problems such as broken links if a pathname is written in one language and the language is subsequently changed. The change in the language and any resulting change in the pathname may not be propagated to all relevant links.

### SUMMARY OF THE INVENTION

One embodiment of the invention relates to an electronic device. The device includes a file system including a data item, and a localization system adapted to localize a received pathname using a stored identifier associated with the pathname. The pathname includes at least one data item name.

In another embodiment, a method of localizing an electronic device includes receiving a pathname including at least one data item name, and localizing the pathname for the electronic device using a stored identifier associated with the pathname.

The following description of certain embodiments serves to explain the invention in greater detail in conjunction with the drawings.

### BRIEF DESCRIPTION OF THE DRAWINGS

FIG. 1 is a schematic illustration of a prior art arrangement;

FIG. 2 is a schematic illustration of an embodiment of a system according to the invention;

FIG. 3 is a flow chart illustrating the operation of a localization system according to an embodiment of the invention; and

FIG. 4 is a flow chart illustrating an exemplary parsing algorithm.

### DETAILED DESCRIPTION OF THE INVENTION

Example embodiments of the present invention provide systems and methods which provide for localization of an electronic device. In this regard, an electronic device is provided with a file system having advantageous features.

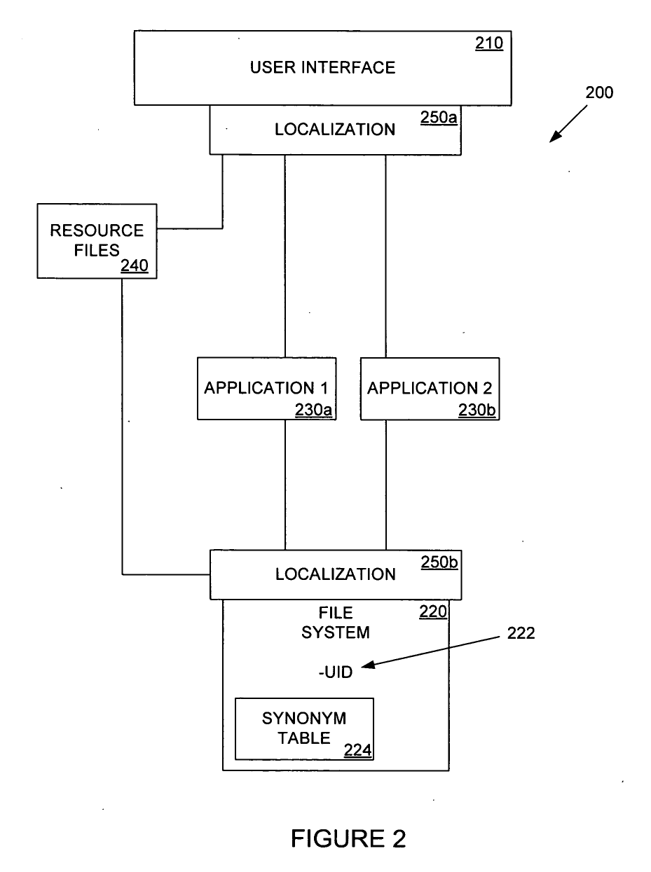

FIG. 2 illustrates an architecture of a system according to an embodiment of the invention. The system 200 may be implemented in an electronic device such as a mobile phone, personal digital assistant, computer or the like. The system 200 includes a user interface 210 adapted to allow a user to communicate and interact with the device 200. In this regard, the user interface 210 may be a graphical user interface, a text-based interface, or any other type of interface. The user interface 210 may receive inputs from the user through, for example, a keypad and may display information to the user on a screen.

A file system 220 is provided to store and manage files or other data items. The files may include files required for operation of certain applications, the operating system or other component of the device 200. The files may also include one or more data items, such as files and directories, accessed by one or more components of the device 200. The file system 220 may be organized in any number of ways. In a particular embodiment, the file system 220 includes a tree structure having directories, sub-directories and files. File systems organized in other manners are contemplated and will be apparent to those skilled in the art.

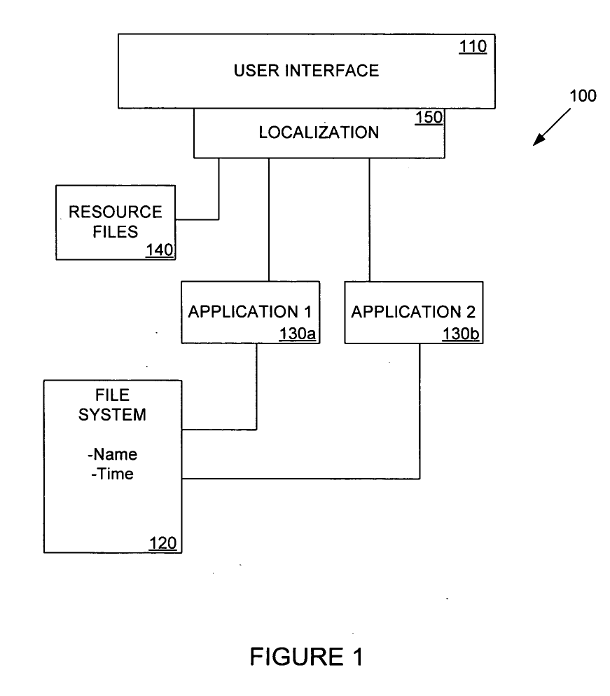

The device is provided with one or more applications 230 to perform various functions and to provide the device 200 with certain capabilities. As noted above with reference to FIG. 1, the system 200 may also include other components, such as an operating system and an API, which are not shown in the figures for simplicity.

The device 200 includes a localization system including localization modules 250a, 250b. Although the localization modules 250a, 250b are shown as two separate and distinct modules, in certain embodiments, the functions may be performed by a single integrated module. The localization modules 250a, 250b may include software which controls the localization of the device 200, including processing communications involving the user interface 210 and the file system 220.

The localization modules 250a, 250b access a set of resource files 240 provided on the device 200. A resource file in the set of resource files 240 corresponds to a different language setting selected by the user or set at the factory. A resource file includes values for various file names, directory names or other text strings. For example, the resource file corresponding to the English setting may include a value for a directory of memoranda as “MEMOS”, while the resource file corresponding to the Finnish setting may include a value for the same directory as “MUISTIOT.” Additional values for other text strings may be included in a resource file.

The file system 220 of the device 200 includes features which facilitate and enhance the localization of the device. A synonym array or table 224 is provided with the file system 220. The array 224 may be implemented as a table, database or other organized data structure. The array 224 includes an array or a matrix of values reflecting values for the same text string in different languages. For example, a directory containing documents may have an array of corresponding synonym values including “DOCS” and “DOKUMENTIT”. A directory may have an associated synonym array. In a particular embodiment, the array 224 may be generated or updated by scanning files in the set of resource files 240 for possible synonyms.

The synonym array 224 may include or be associated with an indexing function which sets the index for the array 224 according to the current language setting of the device 200. Thus, if the current language is English, the index is set to the English value for a text string in the array 224, as well as for other synonym arrays in the device 200. Then, if a desired pathname seeks a file in the document directory that was stored using a different language setting, the localization system determines possible synonyms for “DOCS” in the array and searches the file system for any directories or files corresponding to the synonym.

In one embodiment, a single index is set for all directories in the file system. In this regard, a single preferred synonym array (or table) index may be applied to the entire file system. Thus, a pathname level may use an index corresponding to the selected language.

In another embodiment, the directories may include an additional attribute indicative of an index specific to the directory. In this regard, a directory may be provided with a different index value. Thus, a pathname may use an index at one level corresponding to a first language, such as English, and an index at another level corresponding to a second language, such as Finnish. A system index may be provided to indicate a default index for a directory.

The file system 220 may also include an additional attribute to facilitate the localization of the device. A global unique identifier 222 may be associated with a file, directory and sub-directory of the file system 220. An identifier 222 may be a numerical, textual or alphanumeric string globally identified with a specific file, directory or sub-directory. As used herein, “global” may include across all device, all devices made by a particular manufacturer, all devices in a product line, or other groups of devices or products. Thus, if the required file has a pathname “c:\Docs\Texts\file1.txt”, the call to retrieve that file may be “c:?3451100345?\?198745637?\file1.txt”. It is noted that a demarcation or a marker, such as a question mark (“?”) may be required to alert the file system or the localization system to the existence of a global identifier. A parsing algorithm may be required to translate the called pathname to the file system pathname. In one embodiment, the global identifiers may be implemented as a synonym in the synonym array 224.

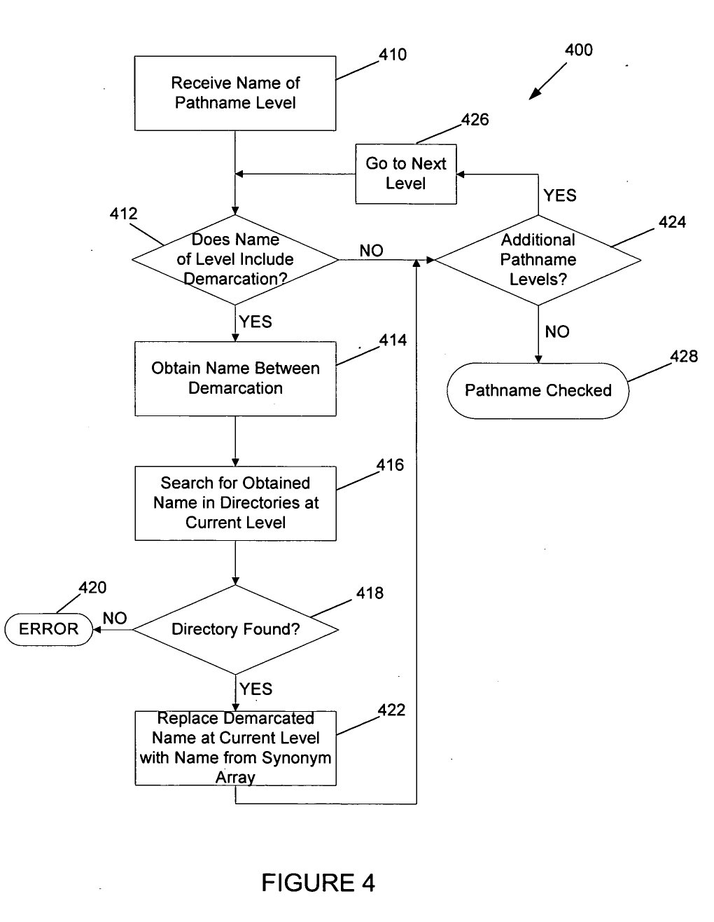

FIG. 4 illustrates an exemplary embodiment of a parsing algorithm for translation of the called pathname to the file system pathname. The algorithm 400 begins at block 410 when the name of a first pathname level is received. The name of a pathname level is typically positioned between slashes (“/”). At block 412, the algorithm determines whether the name of the current level includes a demarcation or a marker, such as the question mark (“?”) described above. If no demarcation or marker exists, the algorithm proceeds to block 424 (described below). If the name of the current level does include a demarcation or a marker, the algorithm obtains the name between the demarcation (block 414), and searches for the obtained name in directories at the current level (block 416). If the search does not result in finding a matching directory name, an error message is generated (block 420). If a matching directory name is found, the algorithm proceeds to block 422 and replaces the demarcated name at the current level with a name from the synonym array. The algorithm then proceeds to block 424.

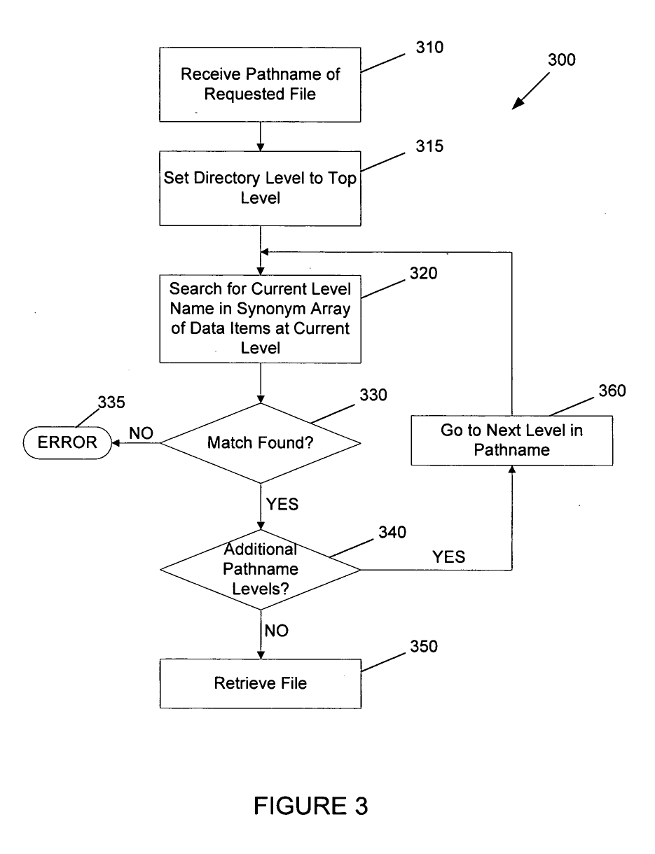

At block 424, the algorithm determines whether additional pathname levels exist. If no additional pathname levels exist, the algorithm completes the checking of the pathname (block 428) and terminates, and localization can occur as described below with reference to FIG. 3, for example. If additional pathname levels do exist, the pathname level is incremented (block 426), and the algorithm returns to block 410 for processing of the next level of the pathname.

The use of a global identifier may be particularly useful when a device is restored using a backup. For example, if a backup is created while the device is set for the English language, and the device is later restored using the backup while the device is set for the Finnish language, the pathnames in the backup may be unrecognizable to the device. With global identifiers saved to the backup, the pathnames are immediately directed to the proper directories and files.

FIG. 3 is a flow chart illustrating an exemplary process for localization of a device. The process 300 may be implemented in the file system, the localization modules, the operating system or in a separate localization software, for example. The process 300 begins when a pathname of a requested file is received (block 310). The file may be requested by the user through a user interface, an application of the device or another module of the device.

Upon receiving the pathname, the process 300 begins to determine whether the pathname exists. For example, assuming the device is set for the English language, if the pathname of the requested file is c:\Docs\file.txt and the file was stored in the file system under the English setting, the file system will find the file to exist under the received pathname. On the other hand, if the file was stored while the device was in the Finnish setting, it may have been stored with a pathname of c:\Dokumentit\file.txt. In this regard, the process 300 first sets the current directory level at the top level (block 315). Thus, in the above example, the current directory level is set at “c:\”.

At block 320, the process searches synonym arrays for one or more directories at the current level of the pathname for synonyms corresponding to he current level name of the requested pathname. In the above example, the process searches for synonyms in the synonym arrays for directories at the “c:\” level for the directory name having a value in English of “DOCS”. The process 300 then determines whether a synonym having a value matching the current level name is found (block 330).

If the process 300 determines, at block 330, that no matches have been found, the process 300 concludes that the pathname does not exist. Accordingly, an error message may be generated (block 335).

On the other hand, if the process 300 determines, at block 330, that a match has been found, the process 300 then determines whether additional directory or sub-directory levels remain to be resolved (block 340). If additional levels remain, the process 300 proceeds to block 360, increments the directory level, and repeats blocks 320, 330 and 340. For example, if the requested file is located in a subdirectory under the “Docs” directory, the procedure of blocks 320, 330 and 340 is repeated for the subdirectory.

Once all levels of the pathname have been resolved, the process retrieves the file (block 350), and the process terminates.

In one embodiment, the system and process described above may be implemented in a system having a removable storage medium, such as a memory card. In this regard, the removable medium may be provided with files and directories while connected to a device for a first language, such as English. If the medium is then removed and inserted into another device for a second language, such as Finnish, the synonym array index in the second device can point to the preferred synonym and access the files and directories using Finnish synonyms for the English pathname.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. An electronic device, comprising:
a file system including a data item; and
a localization system adapted to localize a received pathname using a stored identifier associated with the pathname, the pathname including at least one data item name.

2. The electronic device of claim 1, wherein the stored identifier includes at least one of general text, an attribute value included in a file system and a global identifier.

3. The electronic device of claim 1, wherein the localization system is adapted to search a synonym array for one or more levels of the pathname, the synonym array including a synonym for a value identified by the stored identifier.

4. The electronic device of claim 1, wherein the localization system is adapted to access a resource file corresponding to a current language setting.

5. The electronic device of claim 3, wherein the synonym array includes one or more values gathered from one or more resource files.

6. The electronic device of claim 3, wherein a synonym index corresponding to the synonym array is set for a current language.

7. The electronic device of claim 3, wherein a synonym includes a global identifier for the value.

8. A method of localizing an electronic device, comprising:
a) receiving a pathname including at least one data item name; and
b) localizing the pathname for the electronic device using a stored identifier associated with the pathname.

9. The method of claim 8, wherein the stored identifier includes at least one of general text, an attribute value included in a file system and a global identifier.

10. The method of claim 8, wherein step of localizing includes searching a synonym array for one or more levels of the pathname, the synonym array including a synonym for a value identified by the stored identifier.

11. The method of claim 10, wherein the synonym array includes one or more values gathered from resource files corresponding one or more other languages.

12. The method of claim 10, wherein a synonym index corresponding to the synonym array is set for the current language.

13. The method of claim 10, wherein a synonym includes a global identifier for the value.

14. The method of claim 8, wherein the step of localizing the pathname includes:
c) searching a synonym array for one level of the pathname, the synonym array including a synonym for a value identified by the stored identifier; and
d) repeating step c) for each level in the pathname.

15. A program product, comprising machine readable program code for causing a machine to perform the following method steps:
a) receiving a pathname including at least one data item name; and
b) localizing the pathname for the electronic device using a stored identifier associated with the pathname.

16. The program product of claim 15, wherein the stored identifier includes at least one of general text, an attribute value included in a file system and a global identifier.

17. The program product of claim 15, wherein step of localizing includes searching a synonym array for one or more levels of the pathname, the synonym array including a synonym for a value identified by the stored identifier.

18. The program product of claim 17, wherein the synonym array includes one or more values gathered from resource files corresponding one or more other languages.

19. The program product of claim 17, wherein a synonym index corresponding to the synonym array is set for the current language.

20. The program product of claim 17, wherein a synonym includes a global identifier for the value.

21. The program product of claim 15, further comprising machine readable program code for causing a machine to perform the following method step:
c) searching a synonym array for one level of the pathname, the synonym array including a synonym for a value identified by the stored identifier; and
d) repeating step c) for each level in the pathname.

22. A computer-implemented method of localizing an electronic device, comprising:
a) receiving a pathname including at least one data item name; and
b) localizing the pathname for the electronic device using a stored identifier associated with the pathname.

23. The computer-implemented method of claim 22, wherein the stored identifier includes at least one of general text, an attribute value included in a file system and a global identifier.

24. The computer-implemented method of claim 22, wherein step of localizing includes searching a synonym array for one or more levels of the pathname, the synonym array including a synonym for a value identified by the stored identifier.

25. The computer-implemented method of claim 24, wherein the synonym array includes one or more values gathered from resource files corresponding one or more other languages.

26. The computer-implemented method of claim 24, wherein a synonym index corresponding to the synonym array is set for the current language.

27. The computer-implemented method of claim 24, wherein a synonym includes a global identifier for the value.

28. The computer-implemented method of claim 22, wherein the step of localizing the pathname includes:
c) searching a synonym array for one level of the pathname, the synonym array including a synonym for a value identified by the stored identifier; and
d) repeating step c) for each level in the pathname.
